(19) United States
(12) Patent Application Publication
(10) Pub. No.: US 2023/0123623 A1
(43) Pub. Date: Apr. 20, 2023

(54) GESTURE DETECTING APPARATUS AND GESTURE DETECTING METHOD

(71) Applicant: Mitsubishi Electric Corporation, Tokyo (JP)

(72) Inventors: Mizuki KAWASE, Tokyo (JP); Daisuke OHASHI, Tokyo (JP); Yuki EDO, Tokyo (JP)

(73) Assignee: Mitsubishi Electric Corporation, Tokyo (JP)

(21) Appl. No.: 17/915,176

(22) PCT Filed: May 14, 2020
(86) PCT No.: PCT/JP2020/019231

§ 371 Date: Sep. 28, 2022

(51) Int. Cl. G06V 10/98; G06V 40/20; G06V 20/59; G06V 10/60; G06V 40/10

(52) U.S. Cl. CPC G06V 10/98; G06V 40/28; G06V 20/59; G06V 10/60; G06V 40/11

(57) ABSTRACT

Provided is a gesture detecting apparatus that accurately determines a detection result of a hand of an occupant constituting the gesture. A gesture detecting apparatus includes a detection information acquisition unit, a determination unit, and a rejection unit. The detection information acquisition unit acquires the detection result of the hand in the hand gesture of the occupant of a vehicle and information of the hand in an image in which the hand is detected. The hand of the occupant of the vehicle is detected based on the image captured by an imaging device provided in the vehicle. Based on at least one predetermined condition regarding the information of the hand in the image, the determination unit determines whether or not the hand is a real hand. If the hand is not a real hand, the rejection unit rejects the detection result of the hand detected based on the image.

### TECHNICAL FIELD

The present disclosure relates to a gesture detecting apparatus and a gesture detecting method.

### BACKGROUND ART

In terms of the operation of an in-vehicle device by an occupant of a vehicle, a system has been proposed in which the occupant operates the in-vehicle device by detecting the gesture of a hand of the occupant, without touching the in-vehicle device. For example, the gesture detecting apparatus detects the hand of the occupant based on an image taken by a camera or the like provided in the vehicle. The in-vehicle device operates in response to the gesture of the hand of the occupant; therefore, accuracy is required for the detection of the hand of the occupant in the gesture detecting apparatus. For example, Patent Document 1 proposes an image processing device in which the detection accuracy of a region of interest including a person's hand included in image data is improved.

### PRIOR ART DOCUMENTS

### Patent Documents

[Patent Document 1] Japanese Patent Application Laid-Open No. 2006-350576

### SUMMARY

### Problem to be Solved by the Invention

The gesture detecting apparatus detects a hand of an occupant based on an image. Therefore, depending on the state of the image, the detected object detected as the hand of the occupant may not be the real hand.

The present disclosure has been made to solve the above-mentioned problems, and an object of the present disclosure is to provide a gesture detecting apparatus that accurately determines whether or not a hand detected based on an image is a real hand.

### Means to Solve the Problem

The gesture detecting apparatus includes a detection information acquisition unit, a determination unit, and a rejection unit. The detection information acquisition unit acquires the detection result of the hand in the hand gesture of the occupant of a vehicle and information of the hand in an image in which the hand is detected. The hand of an occupant of the vehicle is detected based on the image captured by an imaging device provided in the vehicle. Based on at least one predetermined condition regarding the information of the hand in the image, the determination unit determines whether or not the hand is a real hand. If the hand is not a real hand, the rejection unit rejects the detection result of the hand detected based on the image.

### Effects of the Invention

According to the present disclosure, gesture detecting apparatus that accurately determines whether or not a hand detected based on an image is a real hand is provided.

The objects, features, aspects, and advantages of the present disclosure will become more apparent from the following detailed description and the accompanying drawings. BRIEF DESCRIPTION OF DRAWINGS

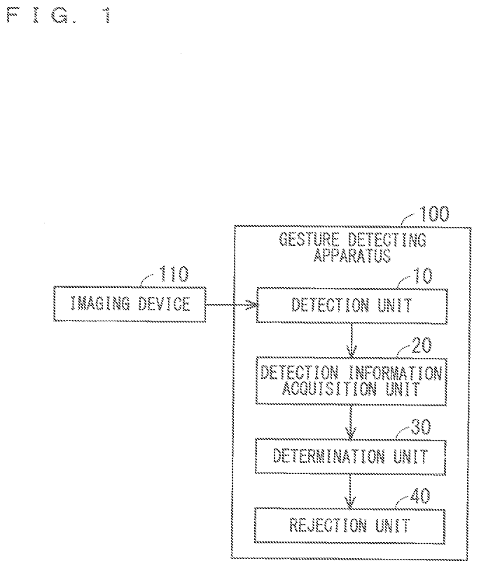

FIG. 1 A functional block diagram illustrating a configuration of a gesture detecting apparatus according to a first embodiment.

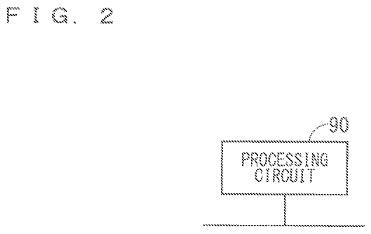

FIG. 2 A diagram illustrating an example of a configuration of a processing circuit included in the gesture detecting apparatus.

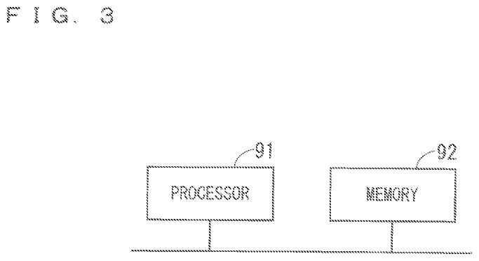

FIG. 3 A diagram illustrating an example of a configuration of a processing circuit included in the gesture detecting apparatus.

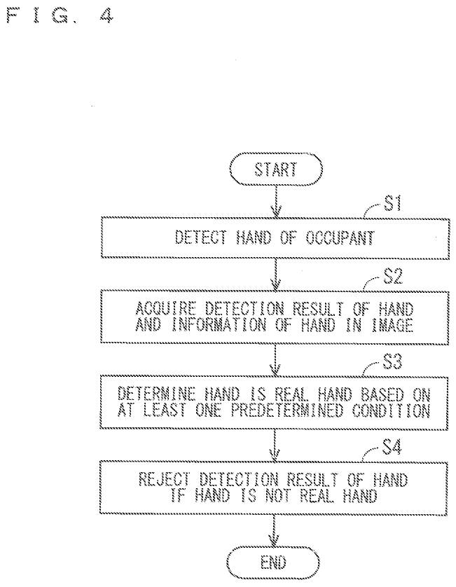

FIG. 4 A flowchart illustrating a gesture detecting method according to the first embodiment.

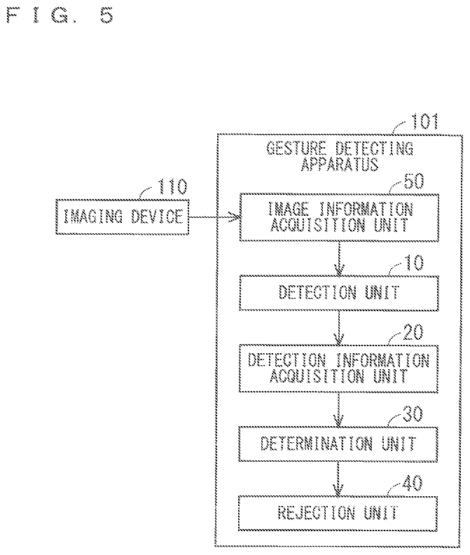

FIG. 5 A functional block diagram illustrating a configuration of a gesture detecting apparatus according to a second embodiment.

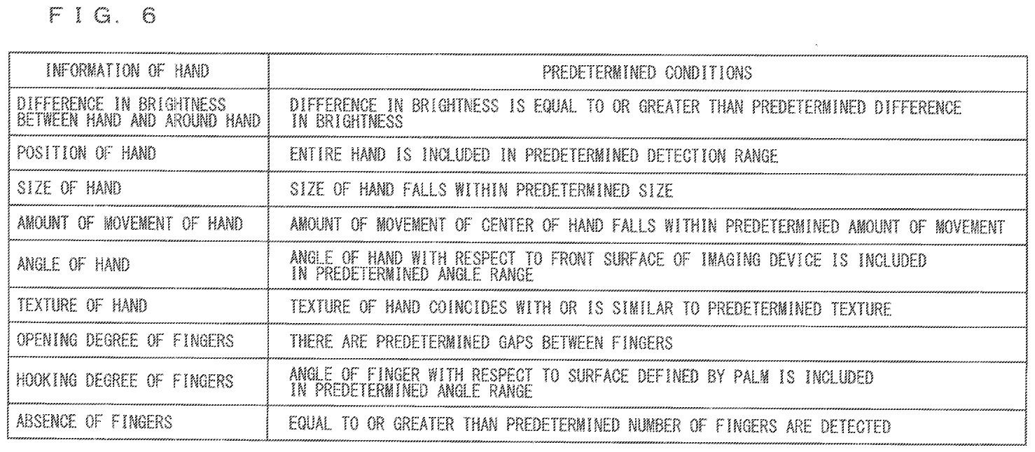

FIG. 6 A diagram illustrating an example of information of a hand in an image and predetermined conditions in which a hand is detected.

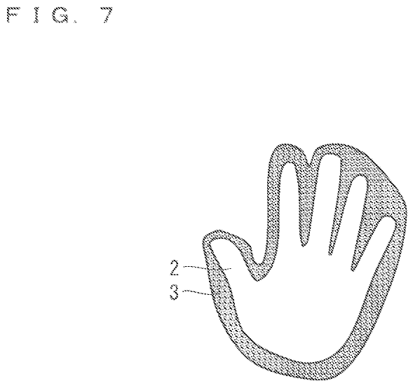

FIG. 7 A diagram illustrating an example of an open hand state detected by the detection unit.

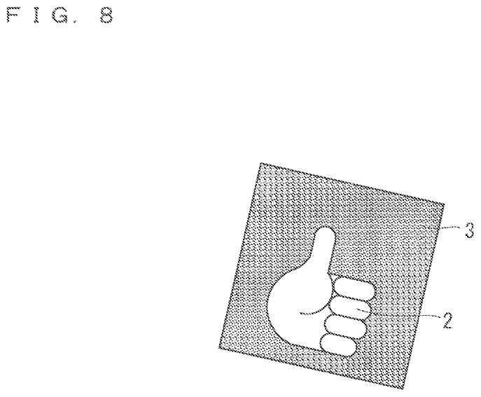

FIG. 8 A diagram illustrating an example of a closed hand state detected by the detection unit.

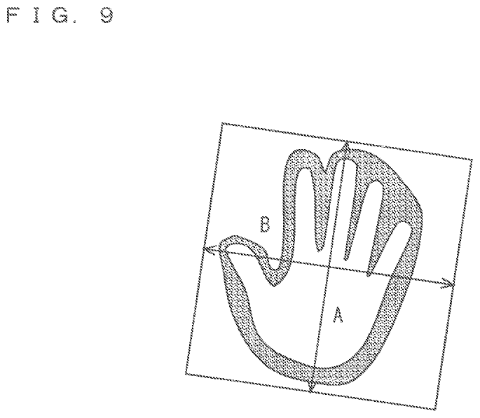

FIG. 9 A diagram illustrating an example of an open hand state detected by the detection unit.

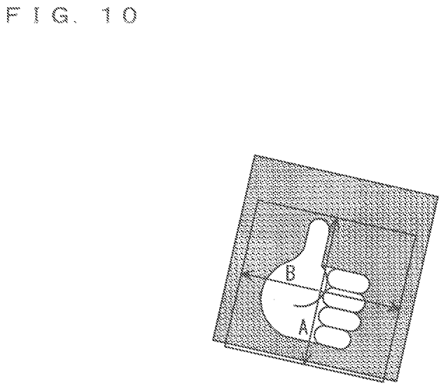

FIG. 10 A diagram illustrating an example of a closed hand state detected by the detection unit.

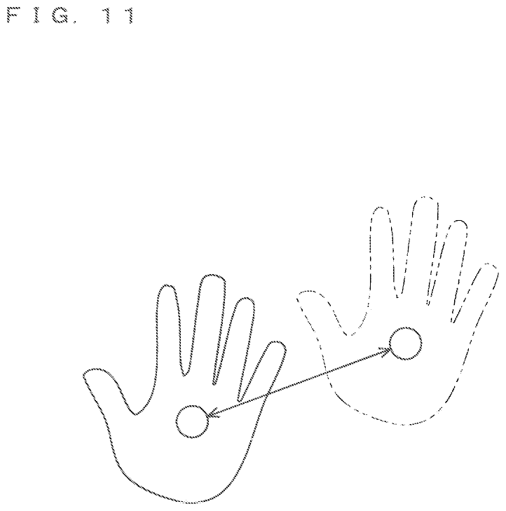

FIG. 11 A diagram illustrating an example of an open hand stale detected by the detection unit.

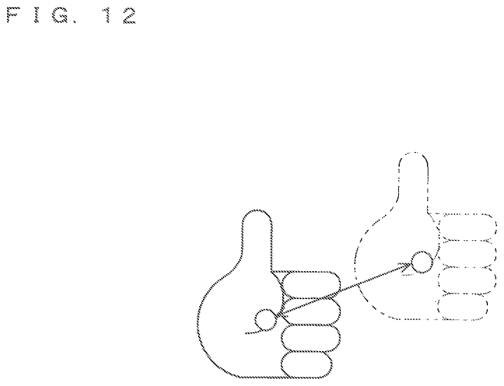

FIG. 12 A diagram illustrating an example of a closed band state detected by the detection unit.

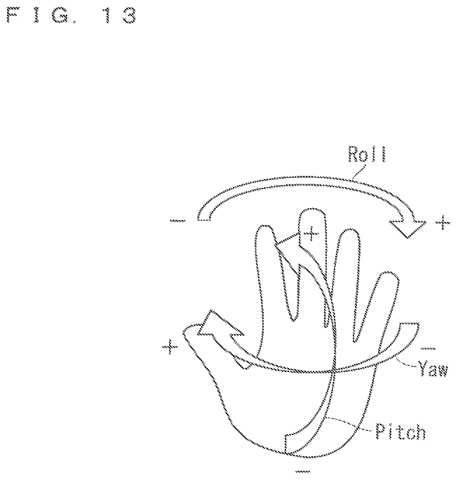

FIG. 13 A diagram illustrating an example of an open hand state detected by the detection unit.

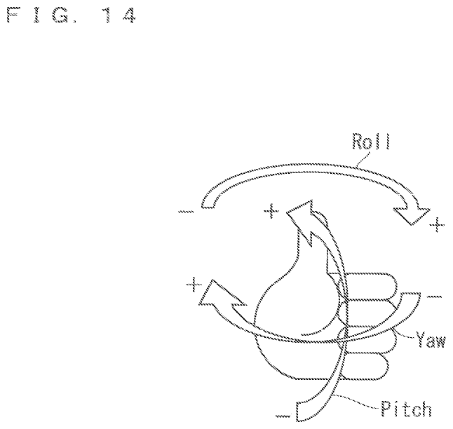

FIG. 14 A diagram illustrating an example of a closed hand state detected by the detection unit.

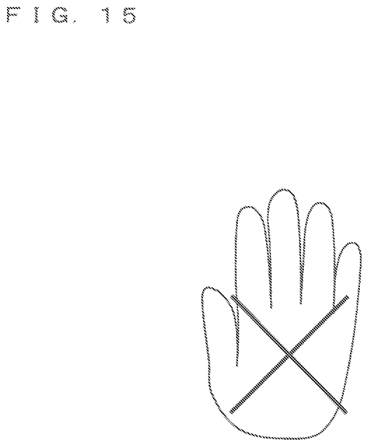

FIG. 15 A diagram illustrating an example of an open hand state detected by the detection unit.

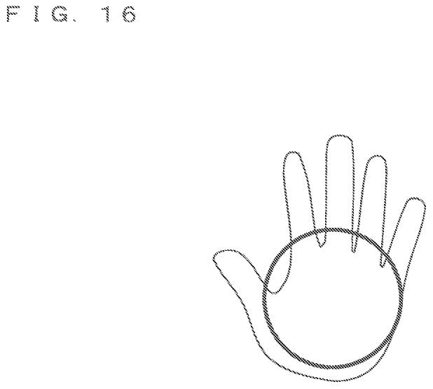

FIG. 16 A diagram illustrating an example of an open hand state detected by the detection unit.

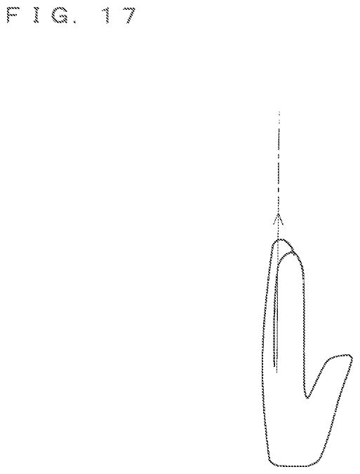

FIG. 17 A diagram illustrating an example of an open hand state detected by the detection unit.

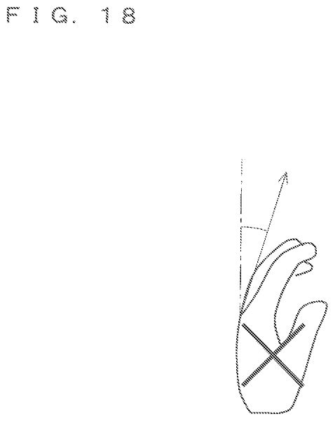

FIG. 18 A diagram illustrating an example of an open hand state detected by the detection unit.

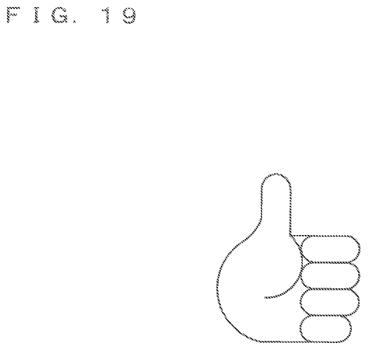

FIG. 19 A diagram illustrating an example of a closed hand state detected by the detection unit,

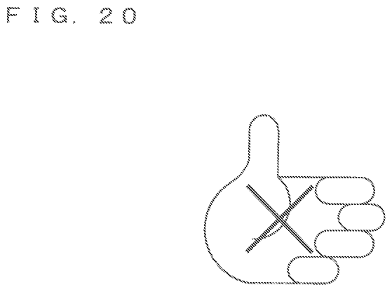

FIG. 20 A diagram illustrating an example of a closed hand state detected by the detection unit.

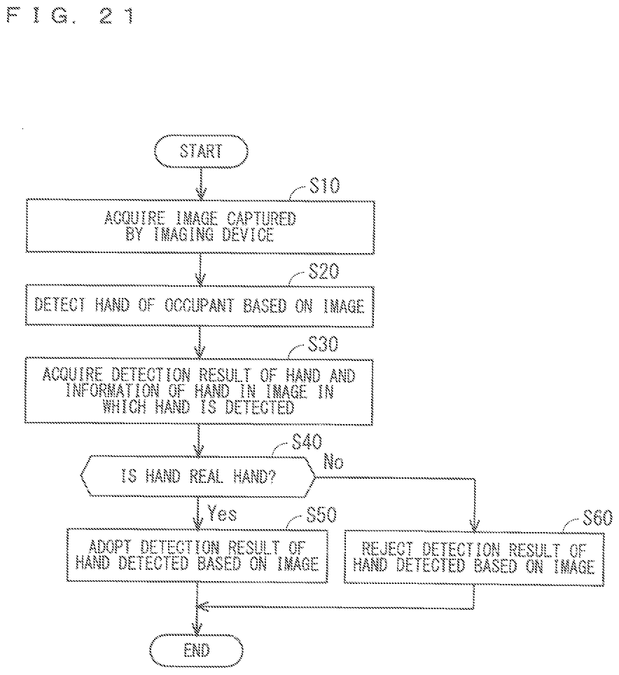

FIG. 21 A flowchart illustrating a process of a gesture detecting method according to the second embodiment,

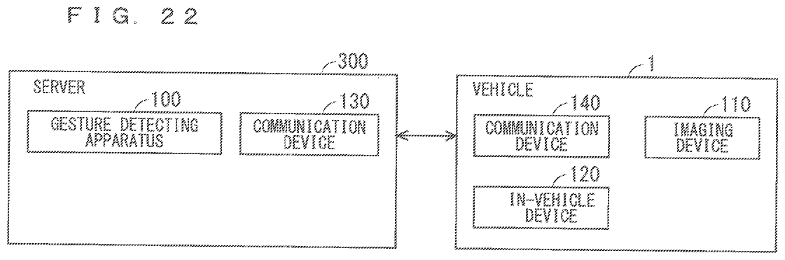

FIG. 22 A functional block diagram illustrating a configuration of a gesture detecting apparatus and a device that operates in association with the gesture detecting apparatus according to a third embodiment.

### DESCRIPTION OF EMBODIMENT(S)

<First Embodiment>FIG. 1 is a functional block diagram illustrating a configuration of a gesture detecting apparatus 100 according to a first embodiment. Further, FIG. 1 illustrates an imaging device 110 as a device that operates in association with the gesture detecting apparatus 100. The imaging device 110 is provided in a vehicle. The imaging device 110 captures an image of an occupant inside the vehicle. The gesture detecting apparatus 100 detects the hand gesture of the occupant of the vehicle based on the image.

The gesture detecting apparatus 100 includes a detection unit 10, a detection information acquisition unit 20, a determination unit 30, and a rejection unit 40.

The detection unit 10 detects the hand of the occupant of the vehicle based on the image captured by the imaging device 110.

The detection information acquisition unit 20 acquires a detection result of a hand and information of the hand in the image in which the hand is detected. The detection result of a hand includes, for example, information such as the position coordinates (detection position) of the hand of the occupant, the contour of the hand, and the area surrounding the hand in the image. The detection result of a hand is information for operating the device (in-vehicle device) mounted on the vehicle by the gesture of the hand. The information of a band in the image is, for example, the brightness of a hand, the position of a hand, the size of a hand, the amount of movement of a hand, the angle of a hand, the texture of a hand (the pattern illustrated by the lightness of brightness), the shape of a hand and the like in an image. The information of a hand is information used to determine whether the detected hand is a real hand.

Based on at least one predetermined condition regarding the information of a hand in the image, the determination unit 30 determines whether or not the hand detected based on the image is a real hand.

If the hand detected based on the image is not a real hand, the rejection unit 40 rejects the detection result of the hand. The gesture detecting apparatus 100 does not use the detection result of the rejected hand by the rejection unit 40 in the subsequent processing, or does not output the detection result of the rejected hand to the outside.

FIG. 2 is a diagram illustrating an example of a configuration of a processing circuit 90 included in the gesture detecting apparatus 100. Each function of the detection unit 10, the detection information acquisition unit 20 the determination unit 30, and the rejection unit 40 is implemented by the processing circuit 90. That is, the processing circuit 90 has the detection unit 10, the detection information acquisition unit 20, the determination unit 30, and the rejection unit 40.

When the dedicated hardware is applied to the processing circuit 90, a processing circuit 90 is, for example, a single circuit, a composite circuit, a programmed processor, a parallel programmed processor, an Application Specific Integrated Circuit (ASIC), or a Field-Programmable Gate Array (FPGA), or a circuit of the combination thereof or the like. The functions of the detection unit 10, the detection information acquisition unit 20, the determination unit 30, and the rejection unit 40 may be individually implemented by a plurality of processing circuits, or may be collectively implemented by one processing circuit.

FIG. 3 is a diagram illustrating an example of a configuration of a processing circuit included in the gesture detecting apparatus 100. The processing circuit includes, for example, a processor 91 and a memory 92. The processor 91 executing the program stored in the memory 92 implements each of the functions of the detection unit 10, the detection information acquisition unit 20, the determination unit 30, and the rejection unit 40. For example, each function is implemented by the processor 91 executing the software or firmware described as a program. As described above, the gesture detecting apparatus 100 has the memory 92 for storing the program and the processor 91 for executing the program.

In the program, a function of the gesture detecting apparatus 100 to acquire the detection result of the hand gesture of the occupant of the vehicle and information of the hand in an image in which the hand is detected. The detection result of the hand is detected based on the image captured by the imaging device 110 provided in the vehicle. Also in the program, a function is described in which whether or not the hand is a real hand is detected based on at least one predetermined condition regarding the information of the hand in the image. Further in the program, a function is described in which, when the hand is not the real hand, the detection result of the hand detected based on the image is rejected. The program causes the computer to implement procedures or methods of the detection unit 10, the detection information acquisition unit 20, the determination unit 30, and the rejection unit 40.

The processor 91 is, for example, a Central Processing Unit (CPU), an arithmetic unit, a microprocessor, a microcomputer, a Digital Signal Processor (DSP), or the like. The memory 92 may be, for example, a non-volatile or volatile semiconductor memory, such as a Random Access Memory (RAM), a Read Only Memory (ROM), a flash memory, an Erasable Programmable Read Only Memory (EPROM), an Electrically Erasable Programmable Read Only Memory (EFPROM), or the like. Also, the memory 92 may be a magnetic disk, a flexible disk, an optical disk, a compact disk, a mini disk, a digital versatile disc (DVD) or the like, or any storage medium used in the future.

Some of the functions of the detection unit 10, the detection information acquisition unit 20, the determination unit 30, and the rejection unit 40 may be implemented by dedicated hardware, and some of the other functions may be implemented by software or firmware. Accordingly, the processing circuit can implement the above each function by hardware, software, firmware, or a combination thereof.

FIG. 4 is a flowchart illustrating a gesture detecting method according to the first embodiment.

In Step S1, the detection unit 10 detects the hand of the occupant of the vehicle based on the image captured by the imaging device 110.

In Step S2, the detection information acquisition unit 20 acquires the detection result of the hand and information of the hand in the image in which the hand is detected.

In Step S3, based on at least one predetermined condition regarding the information of a hand in the image, the determination unit 30 determines whether or not the hand detected based on the image is a real hand.

In Step S4, when the hand detected based on the image is not a real hand, the rejection unit 40 rejects the detection result of the hand. In this manner, the gesture detecting method is completed.

Summarizing above, according to the first embodiment, the gesture detecting apparatus 100 includes, the detection information acquisition unit 20, the determination unit 30, and the rejection unit 40. The detection information acquisition unit 20 acquires the detection result of the hand gesture of the occupant of the vehicle and information of the hand in the image in which the hand is detected. The hand of the occupant of the vehicle is detected based on the image captured by the imaging device 110 provided in the vehicle. Based on at least one predetermined condition regarding the information of a hand in the image, the determination unit 30 determines whether or not the hand is a real hand. If the hand is not a real hand, the rejection unit 40 rejects the detection result of the hand detected based on the image.

Such a gesture detecting apparatus 100 accurately determines whether or not a hand detected based on an image is a real hand.

Also, in the gesture detecting method according to the first embodiment, the detection result of a hand in the hand gesture of the occupant of the vehicle and information of the hand in the image in which the hand is detected are acquired. The hand of the occupant of the vehicle is detected based on the image captured by the imaging device 110 provided in the vehicle. Further, in the gesture detecting method, when whether or not the hand is a real hand is determined based on at least one predetermined condition regarding the information of a hand in the image, and when the hand is not a real hand, the detection result of the hand detected based on the image is rejected.

According to the gesture detecting method, whether or not a hand detected based on an image is a real hand is accurately determined.

Second Embodiment

The gesture detecting apparatus and the gesture detecting method according to the second embodiment will be described. The second embodiment is a subordinate concept of the first embodiment, and the gesture detecting apparatus in the second embodiment includes each configuration of the gesture detecting apparatus 100 in the first embodiment, The description of the same configuration and operation as in the first embodiment will be omitted.

FIG. 5 is a functional block diagram illustrating a configuration of a gesture detecting apparatus 101 according to the second embodiment.

The imaging device 110 is provided in the front center of an interior of a vehicle. The imaging device 110 captures the interior of the vehicle at a wide angle, and captures both the driver's seat and the passenger's seat at the same time. The imaging device 110 is, for example, a camera that captures infrared rays, a camera that captures visible light, and tire like. The gesture detecting apparatus 101 according to the second embodiment detects a hand gesture of the occupant of the vehicle based on the image captured by the imaging device 110. This gesture is a gesture for operating a device (in-vehicle device) mounted on the vehicle. The in-vehicle device is, for example, an air conditioner, an audio, or the like. The gesture detected by the gesture detecting apparatus 101 executes the temperature control of the air conditioner, the volume adjustment of the audio, and the like.

The gesture detecting apparatus 101 includes an image information acquisition unit 50, the detection unit 10, the detection information acquisition unit 20, the determination unit 30, and the rejection unit 40.

The image information acquisition unit 50 acquires an image captured by the imaging device 110.

The detection unit 10 detects the hand of the occupant of the vehicle based on the image. The detection unit 10 detects the hand of the occupant, for example, by matching the information captured in the image with predetermined hand shape. More specifically, the detection unit 10 detects the position coordinates (detection position) of the hand of the occupant in the image. The detection unit 10 may detect the contour of the hand of the occupant or the area surrounding the hand. The area surrounding the hand represents, for example, a rectangular frame area including the contour of the hand. The detection result of the hand in the second embodiment includes at least one of the detection position of the hand, the contour of the hand, and the area surrounding the hand.

The detection information acquisition unit 20 acquires a detection result of the hand and information of the hand in the image in which the hand is detected. The details of the information of a hand will be described later. The detection information acquisition unit 20 acquires, for example, information of a hand from the detection unit 10. Alternatively, based on the image in which the hand is detected, the detection information acquisition unit 20 may acquire the information of a hand by determining the information of the hand by itself.

Based on a predetermined condition regarding the information of a hand in the image, the determination unit 30 determines whether or not the hand detected by the detection unit 10 is a real hand.

FIG. 6 is a diagram illustrating an example of information of a hand in an image in which a hand is detected and predetermined conditions regarding the information of a hand. Based on any one or more predetermined conditions illustrated below, the determination unit 30 according to the second embodiment determines whether or not the hand detected by the detection unit 10 is a real hand. In the following, although the hands detected by the detection unit 10 arc illustrated as an example of an open hand state (open flat hand) and a closed hand state (hand doing thumbs up), the states of hand are not limited thereto The hand detected by the detection unit 10 may include a hand in state indicating a number, a hand in state indicating a direction, or the like.

The detection information acquisition unit 20 acquires, for example, information on the difference in detected brightness in the image in which the hand is detected, as information of the hand. The difference in detected brightness is a difference in brightness between the brightness of the hand and the brightness around the hand. FIGS. 7 and 8 are diagrams illustrating examples of an open hand state (open flat hand) and a closed hand state (hand doing thumbs up) detected by the detection unit 10, respectively. The difference in detected brightness corresponds to tire difference in brightness between the brightness of the hand 2 in the vicinity of the boundary between the hand 2 and the background 3 in the image and the brightness of the background 3 in the vicinity of the boundary. When the difference in detected brightness is equal to or greater than a predetermined difference in brightness, the determination unit 30 determines that the hand detected based on the image is a real hand. That is, the predetermined condition for the above-mentioned information of a hand is a condition regarding the difference in brightness between the brightness of the hand and the brightness around the hand.

The detection information acquisition unit 20 acquires, for example, information of a position of a hand in an image as information of a hand. When the position of the hand is included in the predetermined region, the determination unit 30 determines that the detected hand is a real hand. The predetermined range is, for example, a range in which the detection unit 10 detects a hand based on an image. That is, the predetermined condition for the above-mentioned information of a hand is a condition regarding the position of the hand. Further, the detection information acquisition unit 20 may acquire information on a size of a hand in addition to the position of a hand. Accordingly, the determination unit 30 determines whether or not the entire hand is included in the detection range. For example, when the hand detected by the detection unit 10 is in an open hand state and the entire palm is included in the detection range, the determination unit 30 determines that the hand is a real hand. When the hand detected. by the detection unit 10 is in a closed hand state and the entire hand doing thumbs up is included in the detection range, the determination unit 30 determines that the hand is a real hand.

The detection information acquisition unit 20 acquires, for example, information of the brightness of the hand and the size of the hand in the image in which the hand is detected, as information of the hand. The determination unit 30 performs the determination regarding the size of the hand illustrated below when the brightness of the hand falls within a predetermined brightness range. For example, when a halation is observed in the brightness of the hand, the determination of the size of the hand is not performed. When the size of the hand falls within the predetermined size, the determination unit 30 determines that the hand detected based on the image is a real hand. That is, the predetermined condition for the above-mentioned information of a hand is a condition regarding the brightness of a hand and the size of a hand. FIGS. 9 and 10 are diagrams illustrating examples of an open hand state and a closed hand state detected by the detection unit 10, respectively. The size of the hand is defined, for example, by the number of pixels in tire vertical direction (direction A in each drawing) or the number of pixels in the horizontal direction (direction B in each drawing) of the hand in the image. When the number of pixels falls within the predetermined number of pixels, the determination unit 30 determines that the hand detected based on the image is a real hand.

The detection information acquisition unit 20 acquires, for example, information on an amount of movement of the center of the hand in the image in which the hand is detected, as in formation of the hand. When the amount of movement of the center of the hand falls within the predetermined amount of movement, the determination unit 30 determines that the hand detected based on the image is a real hand. That is, the predetermined condition for the above-mentioned information of a hand is a condition regarding the amount of movement of a hand. The amount of movement is, for example, the number of pixels per unit time. FIGS. 11 and 12 are diagrams illustrating examples of an open hand state and a closed hand state detected by the detection unit 10, respectively. When the hand detected by the detection unit 10 is in an open hand state and the number of pixels corresponding to the amount of movement of the center of the palm tails within a range of a predetermined number of pixels, the determination unit 30 determines that the hand is a real hand. When the band detected by the detection unit 10 is in a closed hand state and the number of pixels corresponding to the amount of movement of the center of the hand doing thumbs up falls within a range of a predetermined number of pixels, the determination unit 30 determines that the hand is a real hand.

The detection information acquisition unit 20 acquires, for example, information on an angle of the hand in the image in which the hand is detected, as information of the hand. When the angle falls within a predetermined angle range, the determination unit 30 determines that the hand detected based on the image is a real hand. That is, the predetermined condition for the above-mentioned information of a hand is a condition regarding the angle of the hand. The angle of the hand is calculated, for example, by the detection unit 10 matching the shape of the hand in the image with the predetermined shape of the hand. The angle of the hand corresponds to the angle formed by the palm and the front surface (the surface including the imaging surface) of the imaging device 110. The palm may be read as the back of hand. FIGS. 13 and 14 are diagrams illustrating examples of an open hand state and a closed hand state detected by the detection unit 10, respectively. Angles of a hand include a roll angle, a pitch angle, and a yaw angle.

The detection information acquisition unit 20 acquires, for example, information on a texture (the pattern illustrated by the lightness of brightness) of the hand in the image in which the hand is detected, as information of the hand. Information on the texture of the hand is obtained, for example, based on the brightness distribution of the hand in the image. When the texture coincides with or is similar to a predetermined texture, the determination unit 30 determines that the hand detected based on the image is a real hand. That is, the predetermined condition for the above-mentioned information of a hand is a condition regarding the texture of the hand.

The detection information acquisition unit 20 acquires, for example, information on a shape of the hand in the image in which the hand is detected, as information of the hand. Based on the shape of the hand, the determination unit 30 determines that the hand is a real hand. That is, the predetermined condition for the above-mentioned information of a hand is a condition regarding a shape of the hand. FIGS. 15 and 16 are diagrams illustrating examples of open hand states detected by the detection unit 10, respectively. In the hand illustrated in FIG. 15, fingers are in contact with one another. On the other hand, in the hand illustrated in FIG. 6, there are gaps between the fingers. The determination unit 30 determines that the hand is a real hand, for example, when there is a gap of a predetermined size between the fingers in the image. In other words, the condition regarding a shape of a hand is the condition regarding the opening degree of the fingers. FIGS. 17 and 18 are diagrams illustrating examples of open hand states detected by the detection unit 10, respectively. In the hand illustrated in FIG. 17, fingers are stretched. On the other hand, in the hand illustrated in FIG. 18, fingers are hooked. For example, when an angle of a finger is within a predetermined angle range with respect to the surface defined by the palm, the determination unit 30 determines that the hand is a real hand. In other words, the condition regarding a shape of a hand is the condition regarding the hooking degree of the fingers. FIGS. 19 and 20 are diagrams illustrating examples of closed hand states detected by the detection unit 10, respectively. The hand doing thumbs up illustrated in FIG. 19 is firmly clenched except for the thumb. On the other hand, in the hand doing thumbs up illustrated in FIG. 20, the fingers other than the thumb are half-open. For example, when the hand is clenched in a predetermined way of the hand clench, the determination unit 30 determines that the hand is a real hand. In other words, the condition regarding a shape of a hand is the condition regarding the way of hand clench in a closed state. Although not illustrated, the determination unit 30 may determine, for example, that the hand is a real hand when the number of fingers of the hand detected by the detection unit 10 is equal to or greater than a predetermined number. In other words, the condition regarding a shape of a hand is the condition regarding the absence of fingers.

If the hand is not a real hand, the rejection unit 40 rejects the detection result of the hand detected by the detection unit 10. The gesture detecting apparatus 101 does not use the rejected detection result of the hand, or does not output the detection result to the outside, “Rejecting” may mean invalidating the detection result of the hand or not adopting it as the detection result of the hand.

FIG. 21 is a flowchart illustrating a gesture detecting method according to the second embodiment.

In Step S10, the image information acquisition unit 50 acquires an image captured by the imaging device 110.

In Step S20, the detection unit 10 detects the hand of the occupant of the vehicle based on the image.

In Step S30, the detection information acquisition unit 20 acquires the detection result of the hand and information of the hand in the image in which the hand is detected.

In Step S40, based on the predetermined condition regarding the information of the hand, the determination unit 30 determines whether or not the hand detected by the detection unit 10 is a real hand. When the hand is determined to be a real hand, Step S50 is executed. When the hand is determined not to be a real hand, Step S60 is executed.

In Step S50, the gesture detecting apparatus 101 adopts the detection result of the hand determined by the determination unit 30 to be a real hand. For example, the gesture detecting apparatus 101 uses the detection result of the real hand in the subsequent processing or outputs the detection result to the outside.

In Step S60, the rejection unit 40 rejects the detection result of the hand determined by the determination unit 30 not to be a real hand. The gesture detecting apparatus 101 does not use the rejected detection result of the hand, or does not output the detection result to the outside. In this manner, the gesture detecting method is completed.

When the imaging device 110 captures a wide range of a room at a wide angle, an object other than the hand to be detected is also captured in the image. Even if an erroneous detection occurs, the gesture detecting apparatus 101 according to the second embodiment rejects an inaccurate detection result among the detection results of the once detected hand based on a predetermined condition. In other words, the gesture detecting apparatus 101 selects only highly accurate detection results. Therefore, the detection accuracy of the hand is improved. As a result, the operation accuracy of the in-vehicle device is improved.

When the occupant operates a device mounted on the vehicle, the occupant may look into the dashboard, center console, or the like of the vehicle to confirm the information displayed thereon. In that state, when the occupant makes a gesture to operate the device, the occupant's head appears larger and brighter than the hand of the occupant in the image. The detection unit 10 erroneously detects the occupant's head in the image as a clenched hand. The gesture detecting apparatus 101 in the second embodiment rejects the detection result of the head which is larger than the predetermined size and has higher brightness than the predetermined brightness. That is, the gesture detecting apparatus 101 rejects the detection result of the erroneously detected occupant's head based on the conditions regarding the size and brightness of the hand in the image. Similarly, a baby's head may be detected as a hand of the occupant. In that case as well, the gesture detecting apparatus 101 rejects the detection result of the erroneously detected baby's head based on the predetermined conditions. As a result, the detection accuracy of the hand is improved.

The imaging device 110 also captures a part other than the hand of the occupant. Therefore, the detection unit 10 erroneously detects the lightness distribution of the brightness based on the crease pattern of the occupant's mask or the crease pattern of the occupant's clothes in the image as the hand of the occupant In terms of the creased parts of the occupant's mask and clothes, the positions thereof do not largely move even when the occupant makes gestures for operating the device. On the other hand, the hand of the occupant is located on the handle during regular driving. When the occupant makes a gesture for operating the device, he/she moves his/her hand to a center console side where the imaging device 110 is provided and then makes a gesture. The gesture detecting apparatus 101 according to the second embodiment rejects the erroneous detection result based on the conditions regarding the amount of movement of the hand in the image. As a result, the detection accuracy of the hand is improved. Similarly, in a case where, in the landscape outside the vehicle, for example, a shape of a cloud is erroneously detected as a hand, and in a case where, when an accessory worn by the occupant is detected as a hand, the same effect is exhibited.

The patterns of clothe creases, gloves, accessories, tattoos, etc. of worn by occupants differ from those of bare hands in the reflection characteristics for near-infrared light. Therefore, when the image captured by the imaging device 110 is a near-infrared image, the gesture detecting apparatus 101 rejects the result of erroneous detection based on the condition regarding the texture of the hand. The condition regarding the texture may include a condition for an infrared image of a hand, a condition for an infrared image of a palmar crease, and the like. As a result, the detection accuracy of the hand is improved.

(First Modification of Second Embodiment)

Based on the image captured by the imaging device 110, the detection unit 10 detects the hand of the occupant of the vehicle and the skeleton of the occupant of the vehicle. When detecting a hand, the detection unit 10 detects the band of the occupant, for example by matching the information captured in the image with a predetermined hand shape. When detecting the skeleton, the detection cant 10 detects the skeleton of the occupant by matching the information captured in the image with a predetermined body shape.

The detection information acquisition unit 20 acquires a detection result of the hand, information of the hand in the image in which the hand is detected, and information of the skeleton. The information of the hand in the first modification of the second embodiment is information on the position of the hand in the image.

Based on the information of the hand and the information of the skeleton of the occupant, the determination unit 30 determines that the hand detected based on the image is a real hand when the hand of the occupant is present at a predetermined position in the skeleton. That is, in the first modification of the second embodiment, the predetermined condition for the information of the hand is a condition regarding the position of the hand in the skeleton of occupant in the image.

As in the second embodiment, if the hand is not a real hand, the rejection unit 40 rejects the detection result of the hand detested b the detection unit 10. The gesture detecting apparatus 101 having such a configuration rejects an inaccurate detection result among the detection results of the once detected hand based on a predetermined condition.

Therefore, the detection accuracy of the hand is improved. As a result, the operation accuracy of the in-vehicle device is improved.

(Second Modification of Second Embodiment)

The determination unit 30 in the second modification of the second embodiment combines a plurality of predetermined conditions and determines whether or not the hand is a real hand. For example, the determination unit 30 performs determination based on the condition regarding the difference in brightness between the brightness of the hand and the brightness around the hand. As a result of the determination, the determination unit 30 makes determination again using the condition regarding the size of the hand for the hand determined to be a real hand. The plurality of predetermined conditions are conditions in which the conditions exemplified in the second embodiment are combined in various ways.

Such a gesture detecting apparatus 101 more accurately detects the hand in the hand gesture of the occupant of the vehicle. This reduces erroneous detection.

<Third Embodiment>

The gesture detecting apparatus illustrated in each of the above embodiments can be applied to a system constructed by appropriately combining a navigation device, a communication terminal, a server, and the functions of applications installed in them. Here, the navigation device includes, for example, a Portable Navigation Device (PND) and the like. The communication terminal includes, for example, a mobile terminal such as a mobile phone, a smartphone and a tablet.

FIG. 22 is a functional block diagram illustrating a configuration of a gesture detecting apparatus 100 and a device that operates in association with the gesture detecting apparatus according to a third embodiment.

The gesture detecting apparatus 100 and a communication device 130 are provided in a server 300. The gesture detecting apparatus 100 acquires an image captured by the imaging device 110 provided in a vehicle 1 via a communication device 140 and the communication device 130. The gesture detecting apparatus 100 acquires a detection result of the hand and information of the hand it the image in which the hand is detected. Based on the predetermined condition regarding the information of the hand, the gesture detecting apparatus 100 determines whether or not the hand is u real hand. If the hand is not a real hand, the gesture detecting apparatus 100 rejects the detection result of the hand detected based on the image. The device (in-vehicle device 120) mounted on the vehicle 1 is controlled based on the gesture by the hand that was not rejected.

By arranging the gesture detecting apparatus 100 in the server 300 in this manner, the configuration of the device group mounted on the vehicle 1 is made simplified.

Further, some of the functions or components of the gesture detecting apparatus 100 may be provided in the server 300, and some of the other parts may be provided in the vehicle 1 in a distributed manner.

In the present disclosure, the embodiments can be combined, appropriately modified or omitted, without departing from the scope of the invention.

While the disclosure has been illustrated and described in detail, the foregoing description is in all aspects illustrative and not restrictive. It is understood that numerous other modifications not having been described can be devised without departing from the scope of the invention.

### EXPLANATION OF REFERENCE SIGNS

1 vehicle, 10 detection unit, 20 detection information acquisition unit, 30 determination unit, 40 rejection unit, 50 image information acquisition unit, 100 gesture detecting apparatus, 101 gesture detecting apparatus, 110 imaging device, 120 in-vehicle device, 130 communication device, 140 communication device, 300 server.

1. A gesture detecting apparatus comprising:
a processor to execute a program, and
a memory to store the program which, when executed by the processor, performs processes of,
acquiring a detection result of a hand in a gesture of the hand of an occupant of a vehicle detected based on an image captured by an imaging device provided in the vehicle and information of the hand in the image in which the hand is detected;
determining whether or not the hand is a real hand, based on at least one predetermined condition regarding the information of the hand in the image; and
rejecting the detection result of the hand detected based on the image, if the hand is not the real hand, wherein
the information of the hand includes information of a position of the hand,
the program further performs a process of acquiring information of skeleton of the occupant detected based on the image, and
the at least one predetermined condition regarding the information of the hand includes a condition regarding the position on the hand in the skeleton of the occupant.

2. The gesture detecting apparatus according to claim 1, wherein
the at least one predetermined condition is a plurality of predetermined conditions, and,
based on the plurality of predetermined conditions, the program performs a process of determining whether or not the hand is the real hand.

3. The gesture detecting apparatus according to claim 1, wherein
the detection result of the hand includes information of a detection position of the hand in the image.

4. The gesture detecting apparatus according to claim 1, wherein
the information of the hand includes information of a difference in brightness between a brightness of the hand and a brightness around the hand.

5. The gesture detecting apparatus according to claim 1, wherein
the information of the hand includes information of a brightness of the hand and a size of the hand.

6. The gesture detecting apparatus according to claim 1, wherein
the information of the hand includes information of an amount of movement of the hand.

7. (canceled)

8. A gesture detecting method comprising:
acquiring a detection result of a hand in a gesture of the hand of an occupant of a vehicle detected based on an image captured by an imaging device provided in the vehicle and information of the hand in the image in which the hand is detected;
determining whether or not the hand is a real hand, based on at least one predetermined condition regarding the information of the hand in the image; and
rejecting the detection result of the hand detected based on the image, if the hand is not the real hand, wherein
the information of the hand includes information of a position of the hand,
the method further comprises a process of acquiring information of skeleton of the occupant detected based on the image, and
the at least one predetermined condition regarding the information of the hand includes a condition regarding the position on the hand in the skeleton of the occupant.
